(19) United States
(12) Patent Application Publication
(10) Pub. No.: US 2022/0112930 A1
(43) Pub. Date: Apr. 14, 2022

(54) FRICTION ASSEMBLY

(71) Applicant: Miba Frictec GmbH, Laakirchen (AT)

(72) Inventors: Markus MUEHLEGGER, Pinsdorf (AT); Falk NICKEL, Gmunden (AT)

(73) Assignee: Miba Frictec GmbH, Laakirchen (AT)

(21) Appl. No.: 17/428,686

(22) PCT Filed: Nov. 26, 2019
(86) PCT No.: PCT/AT2019/060399

§ 371 Date: Aug. 5, 2021

(30) Foreign Application Priority Data
Mar. 13, 2019 (AT) A50219/2019

(51) Int. Cl. F16D 69/02

(52) U.S. Cl. CPC F16D 69/027; F16D 2069/005

(57) ABSTRACT

A friction assembly includes a dry-running disc pack with at least one lining disc and at least one counter disc, which are arranged one behind the other in an alternating manner in an axial direction of the disc pack, and which can be brought into frictional contact with one another, wherein the lining disc has at least one mass-pressed dry-running friction lining.

The invention relates to a friction assembly comprising a dry-running disc pack with at least one lining disc and at least one counter disc, which are arranged one behind the other in an alternating manner in an axial direction of the disc pack, and which can be brought into frictional contact with one another, wherein the lining disc has at least one dry-running friction lining The invention moreover relates to the use of the friction assembly.

In common, dry-running drive systems of motor vehicles, mainly organically resin-bonded friction linings are used.

For example, DE 29 24 540 A describes a product for producing components with metallic compositions, which product is formed by at least a fine steel fiber powder having a loose density of 0.2 to 1.5 g/cm3, the carbon content of which amounts to between 0.95 and 1.10 wt. % and the chromium content of which is between 1.3 and 1.6 wt. %, which is heat treated such that the microscopic structure, observed on an examination plane intersecting a metal particle, displays a fine distribution of spherical iron and chromium carbides having the formula (FeCr)3C in a mixed matrix of high-strength martensite and deformable austenite. This fibrous powder is used for a friction lining for brakes in a proportion of 30 to 85 wt. %, and this friction lining additionally contains mineral and organic filling materials. In particular, friction linings of clutches or brakes are produced therewith. The friction linings contain between 10 and 20% polymer-based phenolic binder.

Modern drive trains should be able to transmit higher power at a lower and lower weight, while at the same time increasing driving comfort and fuel efficiency. Due to the requirement of keeping the weight of the vehicle as low as possible, the frame size of clutches is also strongly restricted. This, in turn, has a strong effect on the loads on the friction lining, since small installation space for the clutch means smaller lining surfaces, which results in higher energy and temperature loads of the friction material.

Metallic friction linings have a higher energy and thermal load high capacity, high friction co-efficients and low abrasion, but also a very strong tendency to frictional vibrations, which can affect the entire drive train and thus have a very negative effect on the driving comfort of the vehicle.

The prior art further describes friction components in which the friction lining is formed by sintered materials. For example, DE 44 43 666 A describes a component, in particular a synchronizer ring, with friction surfaces for friction synchronization in manual transmissions of motor vehicles. The friction surface material of the component described in this DE-A is a sintered bronze substantially pore-free on the surface with metallic and non-metallic additives, which increase the friction behavior, wear resistance and shifting comfort, in the form of up to 6 wt. % zinc, up to 6 wt. % nickel, up to 3 wt. % molybdenum, 1 to 6 wt. % SiO₂ and/or Al₂O₃, optionally 0.2 to 6 wt. % graphite and/or molybdenum disulfide, wherein the remainder is formed by bronze at a defined particle size in the initial powder. This sintered bronze is provided for oil-lubricates parts for friction synchronization in manual transmissions of motor vehicles.

The object of the invention is to provide a friction assembly for dry running, in particular for AWD or FWD drives.

In the initially mentioned friction assembly, the object is achieved by the dry-running friction lining being a mass-pressed friction lining. Moreover, the object of the invention is achieved by using the friction assembly in a clutch or a brake, or in a synchromesh transmission of an AWD drive or FWD drive.

In this regard, it is advantageous that the system can be simplified by omitting lubrication, the friction assembly thus constituting an alternative to conventional wet-running systems in the field of AWD or FWD. In this regard, it is advantageous that virtually no drag torques occur as they do in wet-running friction assemblies. Thus, the friction assembly can be provided with a higher performance. Moreover, it is advantageous that the friction assembly can be subjected to a higher thermal load despite the omission of cooling by means of an oil.

A further improvement of these effects can be achieved if, according to an embodiment variant of the friction assembly, the friction lining is a press sintered friction lining According to a further embodiment variant, the press sintered friction lining is in this regard preferably a sintered metal lining or a press sintered friction lining comprising an organic material.

It is furthermore preferred if the friction lining is arranged on a carrier disc as the carrier disc allows achieving a swift heat dissipation. In this regard, the friction lining may be connected directly to the carrier disc, or according to a different embodiment variant of the friction assembly, be connected to the carrier disc via a connecting layer. With the aid of the connecting layer, it is not only possible to fasten the friction lining on the carrier disc but also to change and adapt further properties of the friction disc.

Moreover, the friction lining may be formed annularly or, according to a different embodiment variant, be segmented. In this regard, the segmentation has the advantage that the segments can be arranged at a distance from one another, and the channels formed thereby can be used for perfusion with air, whereby the thermal load capacity of the friction assembly can also be improved.

For influencing the friction power and/or the thermal stability of the friction assembly, it may be provided according to further embodiment variants that a surface of the friction lining is structured and/or provided with a coating, and/or that a surface of the counter disc is structured and/or provided with a coating.

According to a further embodiment variant of the friction assembly, the friction lining may comprise at least one abrasive, wherein the proportion of the abrasive in the friction lining amounts to a maximum of 5 wt. %. By limiting the proportion to maximum of 5 wt. %, frictional vibrations can be reduced.

According to a different embodiment variant of the friction assembly, it may be provided that the friction lining has a porosity selected from a range having a lower limit of 15% and an upper limit of 40%. Due to the open-pored structure, a friction lining with the desired friction coefficient is easy to produce as lower pressing forces are required during the production of the green compact. In addition, the sintering temperature can be reduced, also due to the high porosity of the sintered body, as a dense sintering is not required. In addition, the porosity leads to an additional damping of the judder vibrations.

According to a further embodiment variant of the friction assembly, the friction lining may comprise a metallic matrix, wherein the proportion of the metallic matrix in the friction lining is selected from a range having a lower limit of 60 wt. % and an upper limit of 90 wt. %. Due to this high proportion, the heat dissipation via the metallic matrix away from the friction surface can be improved, whereby an overheating of the friction lining can be better avoided even with a porosity.

A further reduction of the frictional vibration behavior could be achieved according to an embodiment variant of the friction assembly with the use of dry-running friction linings, the metallic matrix of which is formed from at least one element from a group comprising copper, iron, tin, zinc or alloys therewith or mixtures thereof.

Moreover, according to a further embodiment variant of the friction assembly, the friction lining may comprise a filling material different from the abrasive, wherein its proportion in the friction lining is selected from a range having a lower limit of 5 wt. % and an upper limit of 35 wt. %. The frictional vibration behavior can be further reduced thereby.

It is particularly preferred for the filling material to be a silicate filling material, in particular, according to an embodiment variant, selected from a group comprising mica, feldspar, kieselguhr or mixtures thereof. Especially by the last-mentioned filling materials (and in particular in combination with the mentioned high porosity), high friction coefficients can be achieved despite small proportions of abrasives.

The at least one abrasive can be selected from a group comprising mullite, silicon dioxide, corundum, glass, aluminum oxide (Al₂O₃), as well as mixtures of these, wherein a high abrasive effect can be achieved by these special abrasives, even with low proportion of abrasives.

Furthermore, it is possible that, according to an embodiment variant, at least one solid lubricant is contained in the friction lining, which solid lubricant is selected from a group comprising graphite, in particular natural graphite and/or synthetic primary or secondary graphite, coke and mixtures thereof. By means of these solid lubricants, a high wear can be prevented (in particular even with a high porosity and a low proportion of hard substances and/or abrasives).

In this regard, it is advantageous if the at least one solid lubricant is contained in a proportion selected from a range having a lower limit of 2 wt. % and an upper limit of 30 wt. %, whereby, in turn, correspondingly low wear values can be achieved.

According to a further embodiment variant of the invention, it may be provided that the counter disc in the disc body has multiple openings. The openings serve as a reservoir for the wear debris of the dry-running friction assembly, whereby the wear rate can be reduced substantially.

In order to provide a relatively large total volume for the wear debris without weakening the counter disc too much, it may be provided according to a further embodiment variant that the openings in the disc body of the counter disc are arranged at different radial heights. Therefore, the openings can have smaller dimensions, in particular as this also allows arranging the reservoirs closer to the place where the wear debris is created (as compared to openings formed at the same radial height).

According to a different embodiment variant regarding this, it may be provided that the openings are formed having a circular surface, as they are therefore easier to produce.

For reasons stated above, it is preferably provided according to an embodiment variant that the circular surfaces each have a diameter selected from a range between 2 mm and 10 mm. Hence, a relatively high number of openings can more easily be arranged at different radial heights. In this regard, it has become apparent that openings with a diameter of less than 2 mm accommodate too little wear debris. On the other hand, openings with a diameter of more than 10 mm are already so big that they can influence the friction behavior of the friction assembly.

According to a further embodiment variant of the invention, it may be provided that the openings are formed as elongated holes, which, according to an embodiment variant in this regard, preferably have an arcuate course. It is thereby possible to improve the efficiency of the wear debris intake with relatively slim openings, wherein the efficiency of the wear debris intake can be improved with the arcuate embodiment, in particular when the formation of arches in the direction of rotation of the counter disc is oriented outwards, as thereby, the centrifugal force acting on the abraded particles, the input into the openings and possible the later output out of the openings can be improved.

For the same reason but with slightly less efficiency as compared to the elongated holes, it may be provided that the openings are at least partially arranged on top of one another in the radial direction. Thereby, a kind of “overlapping” of the openings in the radial direction is achieved, although they are separate from one another.

For further improvement of the aforementioned effects, it may be provided according to further embodiment variants of the invention that the openings, which are arranged at the same radial height, are each arranged offset by an angle selected from a range of 20° to 60°, and/or that the openings, which are arranged at different radial heights, are each arranged offset by an angle selected from a range of 5° to 25°.

For the purpose of better understanding of the invention, it will be elucidated in more detail by means of the figures below.

These show in a simplified schematic representation:

FIG. 1 a cutout from a disc pack of a friction assembly;

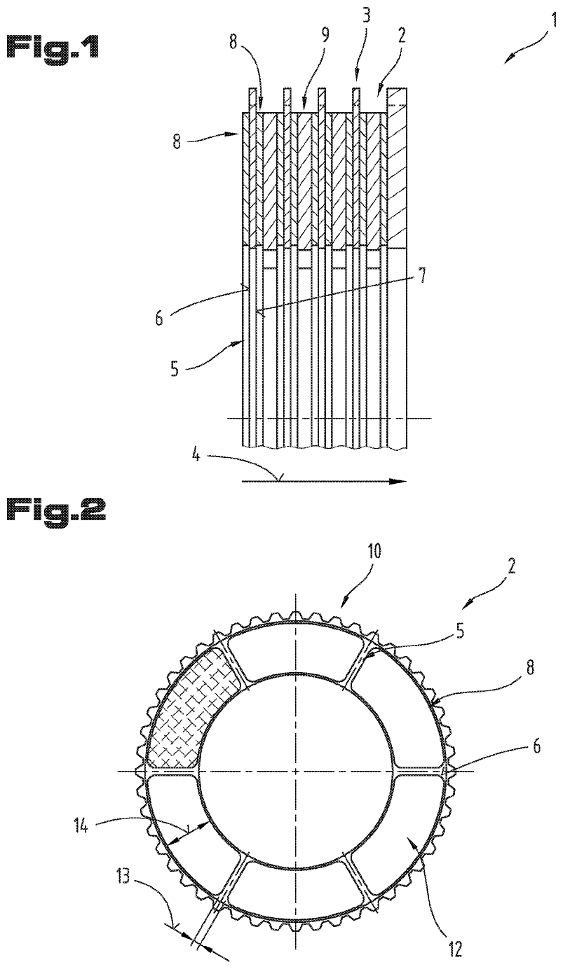

FIG. 2 a friction disc;

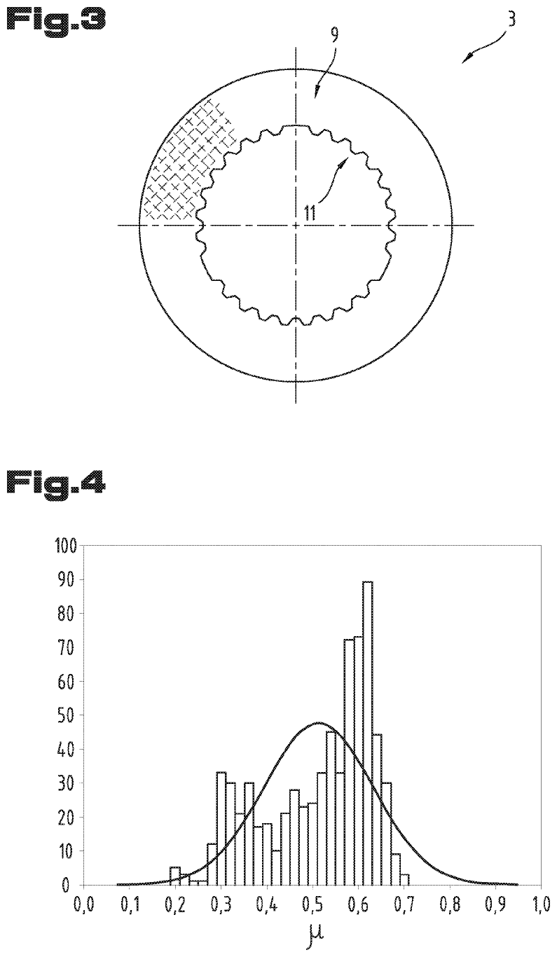

FIG. 3 a counter disc;

FIG. 4 a representation of the friction coefficient accuracy for a friction lining according to the state of the art;

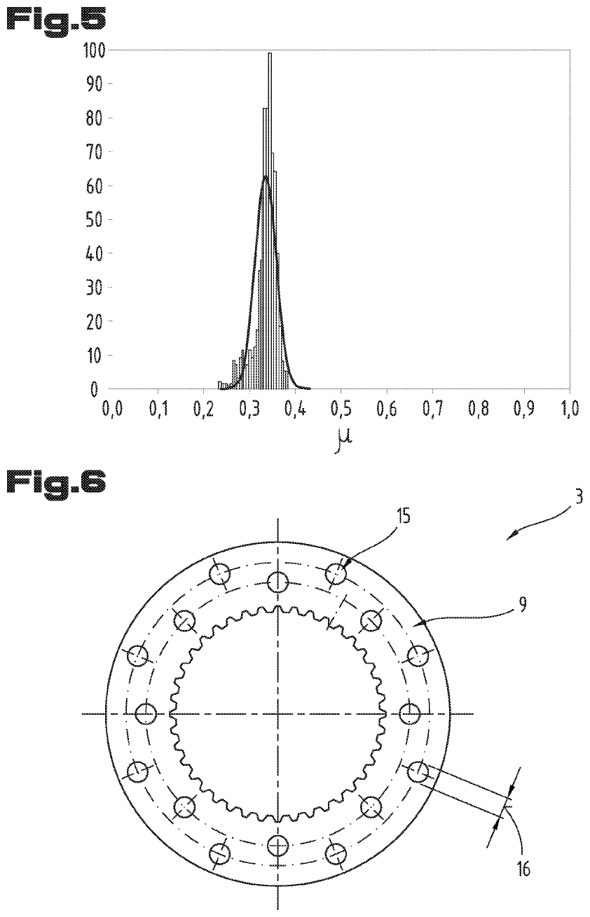

FIG. 5 a representation of the friction coefficient accuracy with a friction lining used in the friction assembly according to the invention;

FIG. 6 a first embodiment variant of a counter disc with openings;

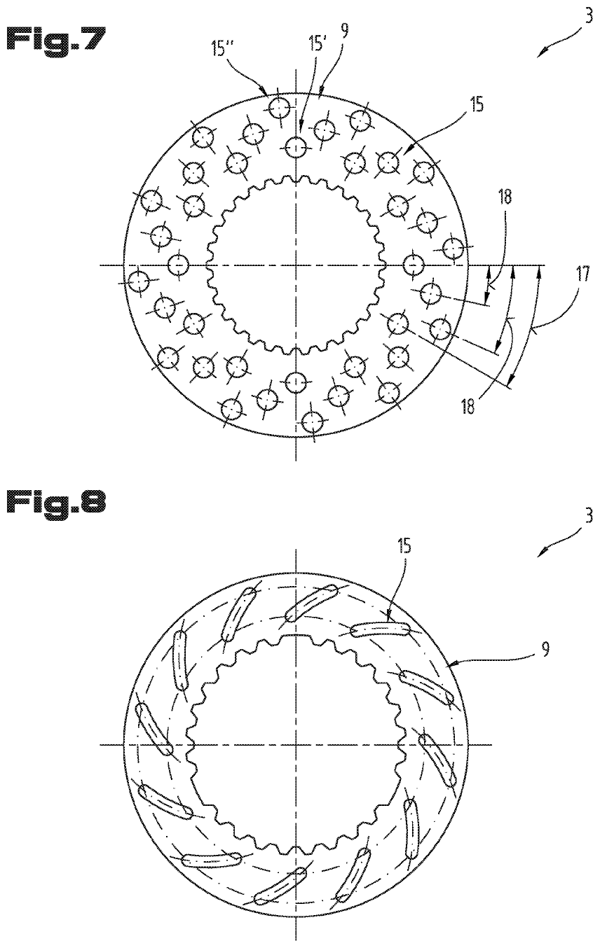

FIG. 7 a second embodiment variant of a counter disc with openings;

FIG. 8 a third embodiment variant of a counter disc with openings.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

All standards referred to in this description refer to the latest version valid at the date of filing of the present application, unless otherwise stated.

FIG. 1 shows a disc pack 1 of a friction assembly not shown in further detail. The disc pack 1 comprises at least one lining disc 2, in particular multiple lining discs 2, and at least one counter disc 3, in particular multiple counter discs 3, which can also be referred to as friction discs. The lining discs 2 are arranged in an axial direction 4 one behind the other, alternating with the counter plates 3. Via a corresponding actuation mechanism, the lining discs 2 are adjustable relative to the counter discs 3 in the axial direction 4, such that a frictional engagement is established between the lining discs 2 and the counter discs 3.

In the embodiment variant of the friction assembly with the disc pack 1 according to FIG. 1, the lining discs 2 are designed as so-called outer discs and the counter discs 3 as so-called inner discs. However, the formation of these can also be the other way around, such that the lining discs 2 form the inner discs and the counter discs 3 form outer discs.

The lining disc 2 can better be seen from FIG. 2 and the counter disc 3 can better be seen from FIG. 3. Since all lining discs 2 and/or all counter discs 3 of a disc pack 1 and/or of a friction assembly are preferably designed equally, below, merely one lining disc 2 and one counter disc 3 are elaborated on. These statements can correspondingly be applied to lining discs 2 and/or counter discs 3. The number of the lining discs 2 and the counter discs 3 can in general for example be selected from a range of 1, in particular 2, to 20 in each case. Accordingly, the number of lining and counter discs 2, 3 shown in FIG. 1 is not to be understood as limiting.

The lining discs 2 comprise an at least approximately angular carrier disc 5 with a first surface 6 and a second surface 7 opposite thereto the axial direction 4. On the first and/or on the second surface 6, 7, in each case, at least one friction lining 8 is arranged.

The counter disc 3 comprises an at least approximately angular disc body 9, which is, however, free of friction linings

The lining discs 2 comprise at least one driver element 10, for example in the form of an external toothing, on a radially outer end face. Likewise, the counter discs 3 comprise at least one driver element 11 on a radially inner end face. Via the driver elements 10, 11, a connection preventing rotation relative to another component of the friction assembly can be established, for example of a shaft in case of the counter discs 2 or of the housing of the friction assembly in case of the lining discs 3, as is per se known. It should again be pointed out that the discs can be of reversed design, i.e. the lining discs 2 can comprise the driver elements 11 and the counter discs 3 can comprise the driver elements 10, and accordingly the rotationally fixed connection with the respective other component of the friction assembly can also be established.

This general structure of a disc pack 1 is known from the prior art. As regards further details, reference is thus made to the relevant prior art.

The disc pack 1 is part of a dry-running disc friction system, in particular a dry-running disc clutch, a brake, a holding brake, a differential lock, etc. Preferably, the disc pack 1 is used in a friction assembly of an AWD drive (All Wheel Drive) or an FWD drive (Front Wheel Drive).

The friction lining 8 preferably is a mass-pressed dry-running friction lining For this purpose, a mixture can be produced from the components of the friction lining 8, which mixture is then pressed into a pellet in a press, optionally in a hot press at an elevated temperature (e.g. at a temperature between 100° C. and 190° C.), or in a cold state at room temperature.

According to an embodiment variant, it can be provided for that the friction lining 8 is a press sintered friction lining. The press sintered friction lining may be a sintered metal lining as it will be described below, or a press sintered friction lining comprising an organic material.

However, it is also possible that the friction lining 8 is an organic friction lining 8. Regarding the materials, reference is made to the following statements.

The friction lining 8 can be manufactured by means of a band sintering process or by means of pressure sintering or by means of a DHP process (Direct Hot Pressing).

The friction lining 8 can have a layer thickness of between 0.5 mm and 5 mm.

As already mentioned, the friction lining 8 is preferably arranged on the carrier disc 5. The carrier disc 5 preferably consists of a steel. However, other iron-based alloys can also be used. Likewise, copper-based alloys, such as brass or bronze, or other metallic alloys can also be used.

The carrier disc 5 can have a thickness of between 0.4 mm and 5.5 mm.

The friction lining 8 can be arranged directly on the carrier disc 5, for example be pressed onto it or sintered onto it. However, it is also possible that the friction lining 8 is connected to the disc carrier 5 via a connecting layer, which is arranged between the disc carrier 5 and the friction lining 8. The connecting layer can for example be a layer of solder, e.g. a brazing solder based on a CuSn or CuZn alloy, or an adhesive layer, e.g. of organic and inorganic high-temperature adhesive.

The carrier disc 5 can also comprise at least one friction lining 8 on just one of the surfaces 6, 7 or on both surfaces 6, 7 (as shown in FIG. 1).

It is also possible that the friction lining 8 is designed as a closed, one-piece ring, i.e. extends continuously over 360°. According to another embodiment variant, however, it can also be provided for that the friction lining 8 is segmented, as shown in FIG. 2. A friction lining 8 with six segments 12 is shown. However, this number is not to be considered restricting. In particular, the friction lining 8 can have between two and thirty segments 8. A friction component can, however, also comprise just one such segment 8, which is not designed as a closed ring. Other forms of the friction lining are also possible, e.g. cylindrical, cuboid, etc.

The segments 8 are arranged to be spaced apart from one another in the circumferential direction of the friction disc 8. In this regard, a distance 13 can amount to between 0 mm and 20 mm, in particular between 1 mm and 15 mm.

Edges and/or rims of the segments 12 can be designed to be slanted or rounded. In this regard, the rounding radius can amount to between 0.5 mm and 6 mm, in particular between 1 mm and 4.5 mm.

A radial width 14 of the friction lining 8 and/or the segments 12 can be selected from a range between 5 mm to 40 mm.

The grooves created between segments 12 by the spacing of the segments 12 can have a rectangular, square, trapezoidal, round, etc. cross section.

The counter disc 3 preferably consists of a steel. However, other iron-based alloys can also be used. Likewise, copper-based alloys, such as brass or bronze, or other metallic alloys can also be used.

The counter disc 3 can have a thickness of between 0.5 mm and 6 mm.

The outer diameter and the inner diameter of the lining discs 2 and the counter discs 3 can be adjusted to the corresponding circumstances. The same applies to the ratio of outer diameter to inner diameter.

According to a different embodiment variant, it may moreover be provided that the surface of the friction lining 8 and/or the surface of the counter disc 3 and/or the surface(s) 7, 8 are designed to be structured, as it is adumbrated in dashed lines in FIGS. 2 and 3 for the surface of the friction lining 8 and the surface of the counter disc 3. The structuring can be designed in the form of grooves, for example grooves with concentric or radial extent, grooves in the shape of a trapezoidal pattern, as waffle grooves, etc. Discrete elevations in the form of knobs or the like are also possible as surface structuring.

However, the surface of the friction lining 8 and/or the surface of the counter disc 3 and/or the surface(s) 7, 8 may also be designed to be pressed smooth. Moreover, a combination of surfaces that are (pressed) smooth and structured surfaces is possible.

The depth of the grooves of the surface structure(s) can be selected from a range of 0.1 mm to 2 mm, in particular between 0.5 mm and 1.5 mm. The width of the grooves (in the circumferential direction of the friction disc 8) can be selected from a range of 1 mm to 3 mm, in particular between 1 mm and 2.5 mm. The grooves can have a rectangular, square, trapezoidal, round, etc. cross section. All grooves of a surface structure can be designed equally. However, it is also possible that different grooves (width, depth, shape) are combined with one another in one surface.

According to a further embodiment variant, it may be provided that the surface of the friction lining 8 and/or the surface of the counter disc 3 is provided with a coating. The coating may be made from melted metal oxides from the group Al, Mg, Fe, Si, or Ti, or organic coatings with filling materials made from Al, Mg, Fe, Si, Ti, or carbides. Furthermore, the coating may also be embodied based on Cu or Cu alloys.

The friction lining 8 can have a porosity larger than 10%. In particular, the friction lining can have a porosity selected from a range having a lower limit of 15% and an upper limit of 40%. In this regard, the porosity refers to the relative proportion of the cavity volume in the total volume of the friction lining 8. The porosity can be measured by Hg intrusion and extrusion: Pore volume according to ISO 15901-1 (DIN 66133).

For further improvement of the properties of the friction lining 8, the porosity can also be selected from a range having a lower limit of 20% and an upper limit of 35%, in particular selected from a range having a lower limit of 25% and an upper limit of 30%.

The friction lining 8 may consist of at least a metallic matrix, at least one abrasive, at least one filling material and possibly at least one solid lubricant, wherein all components add up to 100 wt. %.

The friction lining 8 may be designed to be free of binding agents and have a friction lining body. Binder-free means that the friction lining 8 does not comprise organic resins as binders. The friction lining body comprises in this case a metallic matrix, at least one abrasive, solid lubricants, and optionally at least one filling material and/or consists thereof, wherein in the latter case all components of the friction lining body add up to 100 wt. %.

The proportion of the metallic matrix in the friction lining 8 can be selected from a range having a lower limit of 60 wt. % and an upper limit of 90 wt. %. The proportion of the metallic matrix can further be selected from a range having a lower limit of 70 wt. % and an upper limit of 80 wt. %.

Preferably, for the metallic matrix at least one metal or a metal alloy is used, which has/have a hardness according to Vickers selected from a range having a lower limit of 30 HV10 and an upper limit of 80 HV10. By means of metals of this hardness, it is possible that at least a part of the abrasive effect of the friction lining is maintained by the metallic matrix, in particular if the metallic matrix is not post-treated by grinding or the like to smooth the surface.

In particular, for the metallic matrix at least one metal or a metal alloy can be used, which has/have a hardness according to Vickers selected from a range having a lower limit of 40 HV10 and an upper limit of 60 HV10.

For example, the metallic matrix can be formed from at least one element from a group comprising copper, iron, tin, zinc, or alloys therewith and mixtures thereof.

Preferably, the proportion of the abrasive in the friction lining 8 amounts to a maximum of 5 wt. %.

The at least one abrasive can be selected from a group comprising mullite, silicon dioxide, corundum, glass, aluminum oxide (Al₂O₃), as well as mixtures of these, wherein a high abrasive effect can be achieved by these abrasives, even with such low percentages of abrasives.

The proportion of the at least one filling material in the friction lining 8 can be selected from a range having a lower limit of 5 wt. % and an upper limit of 35 wt. %. It is particularly preferred for the filling material to be a silicate filling material, in particular, according to an embodiment variant, selected from a group comprising mica, feldspar, kieselguhr or mixtures thereof. Especially by the last-mentioned particular filling materials in combination with the high porosity, high friction coefficients can be achieved despite small proportions of abrasives.

The ratio of filling material(s) to abrasive(s) can be selected from a range having a lower limit of 1:1 and an upper limit of 5:1. Within these limits, a maximum of the abrasive effect of the dry-running friction lining according to the invention with a small proportion of the abrasive could be observed.

The friction lining 8 has a first surface and a second surface located opposite the first in the axial direction 4, wherein the proportion of the abrasive may increase from the first surface in the direction toward the second surface. Hence, a design having a higher proportion of the abrasive in the friction surface is possible. On the other hand, however, it is also possible to achieve a better cohesion of the friction lining 8 with a carrier disc 5 by forming toothings or micro-welds. Depending on the desired property, it is thus possible to select the increased proportion of the at least one abrasive in a surface.

Furthermore, it is possible that at least one solid lubricant is contained in the metallic matrix, which solid lubricant is selected from a group comprising graphite, in particular natural graphite and/or synthetic primary or secondary graphite, coke and mixtures thereof. In this regard, it is advantageous if the at least one solid lubricant in the metallic matrix is contained in a proportion selected from a range having a lower limit of 2 wt. % and an upper limit of 30 wt. %, whereby, in turn, correspondingly low wear values can be achieved. In particular, the proportion of the at least one solid lubricant in the friction lining can be selected from a range having a lower limit of 3 wt. % and an upper limit of 15 wt. % and/or be selected from a range having a lower limit of 4 wt. % and an upper limit of 7.5 wt. %.

It is particularly preferred if the ratio of abrasive to solid lubricant is selected from a range having a lower limit of 1:7 and an upper limit of 1:20. Due to this coordinated proportion of abrasive to solid lubricant, the wear properties could be improved significantly.

The ratio of abrasive to solid lubricant preferably amounts to 1:10.

The friction lining 8 may possibly contain an organic binding agent. The organic binding agent may be selected from a group comprising phenolic resins, possibly mixed with a silicone resin, polyvinyl fluoride, polyvinylidene fluoride, polyesterimides, polyimide resins, such as carborane imides, aromatic polyimide resins, hydrogen-free polyimide resins, polytriazo-pyromellithimides, polyamideimides, in particular aromatic ones, polyaryletherimides, possibly modified with isocyanates, polyetherimides, possibly modified with isocyanates, acrylic resins, epoxy resins, epoxy resin esters, polyamide 6, polyamide 66, polyoxymethylene, polyaryl ethers, polyaryl ketones, polyaryletherketones, polyarylether-etherketones, polyetheretherketones, polyether ketones, polyethylenesulfides, allylene sulfides, polytriazo-pyromellithimides, polyesterimidies, polyarylsulfides, polyvinylenesulfides, polyphenylene sulfide, polysulfones, polyethersulfones, polyarylsulfones, polyaryloxides, polyarylsulfides or copolymers thereof as well as mixtures thereof.

Below, some exemplary compositions of the friction lining 8 are listed, which, however, do not have a limiting character. All indications regarding the compositions are provided in wt. %.

### EXAMPLE 1

60.0% copper, 10.0% iron, 15.0% feldspar, 10.5% synthetic graphite, 4.5% aluminum oxide

### EXAMPLE 2

60.0% copper, 2.0% tin, 20.0% kieselguhr, 12.0% synthetic graphite, 2.0% natural graphite, 4.0% corundum

### EXAMPLE 3

60.0% copper, 14.0% iron, 8.0% mica, 10.5% synthetic graphite, 3.0% synthetic graphite, 4.5% aluminum oxide

### EXAMPLE 4

64.0% copper, 3.0% Zinc, 14.0% mica, 12.0% synthetic graphite, 5.0% coke, 2.0% silicon oxide

### EXAMPLE 5

69.0% copper, 8.0% mica, 10.0% feldspar, 10.5% synthetic graphite, 2.5% mullite

### EXAMPLE 6

70.0% copper, 15.0% iron, 5.0% coke, 4.0% natural graphite, 4.5% molybdenum disulfide, 1.5% silicon oxide

### EXAMPLE 7

75.0% copper, 8.0% kieselguhr, 4.0% molybdenum disulfide, 10.5% synthetic graphite, 2.5% mullite

### EXAMPLE 8

50.0% copper, 10.0% iron, 10.0% kieselguhr, 15.0% mica, 9.0% synthetic graphite, 4.5% molybdenum disulfide, 1.5% silicon oxide

### EXAMPLE 9

70.0% copper, 4.0% tin, 8,0% kieselguhr, 4.0% molybdenum disulfide, 8.0% Graphite, 2.0% natural graphite, 4.0% corundum

### EXAMPLE 10

40.0% copper, 25.0% iron, 20.0% feldspar, 11.5% synthetic graphite, 3.5% aluminum oxide

According to an embodiment variant of the invention, it is further possible that at least two different solid lubricants are contained in the metallic matrix, which are selected from a group consisting of hexagonal boron nitride and metal sulfides with at least one metal from the group of tungsten, iron, tin, copper, bismuth, antimony, chromium, zinc, silver, manganese, molybdenum. In particular, besides hexagonal boron nitride, the group of solid lubricants can also comprise Sb₂S₃, Bi₂S₃, Cr₂S₃, Cu₂S, CuS, CuFeS₂, FeS, FeS₂, MnS, MoS₂, Ag₂S, WS₂, SnS, SnS₂, Sn₂S₃, ZnS. In this regard, it can be provided for that the solid lubricants are formed of at least two metal sulfides comprising the same metal, i.e. for example of SnS and SnS₂.

In addition to these solid lubricants, graphite, in particular natural graphite or synthetic primary or secondary graphite, coke and mixtures thereof can be contained.

It is advantageous if the total proportion of solid lubricants in the metallic matrix is selected from a range having a lower limit of 5 wt. % and an upper limit of 30 wt. %. In particular, the total proportion of solid lubricants in the friction lining 8 can be selected from a range having a lower limit of 6 wt. % and an upper limit of 15 wt. % and/or be selected from a range having a lower limit of 8 wt. % and an upper limit of 10 wt. %.

Tin sulfides can be contained in a total proportion between 2 wt. % and 7 wt. %.

The total proportion of iron sulfides in the friction lining body can amount to between 1 wt. % and 5 wt. %.

The total proportion of hexagonal boron nitride in the friction lining body can amount to between 1 wt. % and 6 wt. %. If hexagonal boron nitride and graphite are contained, the quantity ratio of graphite to hexagonal boron nitride can be selected from a range of 3 to 6.

It can also be provided for that the solid lubricants are partly of a natural original and partly synthetically produced. In this regard, it is advantageous if a quantity ratio of natural solid lubricants to synthetic solid lubricants is selected from a range of 1.5 to 5. In general, the quantitative proportion of synthetic solid lubricants can amount to between 0.5 wt. % and 5 wt. %.

The synthetic solid lubricants are in particular produced on the basis of graphite and on the basis of metal sulfides and/or synthetic graphite and synthetic metal sulfides from the aforelisted group of metals.

Below, some preferred example of such solid lubricant compositions of the friction lining 8 are listed, which, however, so not have a limiting character. All indications regarding the compositions are provided in wt. %.

### Example a.)

2% to 6 SnS+1% to 5% SnS₂, for example 4% SnS+3% SnS₂

### Example b.)

0.5% to 1.5% SnS+1% and 3% SnS₂+0.5-% and 3% Sn₂S₃+3.5% and 7.5% hexagonal boron nitride, for example 1% SnS+2 SnS₂+1.5% Sn₂S₃ +5.5% hexagonal boron nitride

### Example c.)

6% to 10% SnS+2% and 6% FeS, for example 8% SnS+4% FeS

### Example d.)

1% to 5% SnS+2% to 6% FeS+0.5% to 1% synthetic solid lubricant based on zinc sulfide with tungsten sulfide and with graphite, for example 3% SnS+4% FeS+0.75% synthetic solid lubricant

### Example e.)

2% to 6% SnS+1% to 3.5% FeS+0.5% to 4% hexagonal boron nitride+0.5% to 3% synthetic solid lubricant based on zinc sulfide with tungsten sulfide and with graphite, for example 4% SnS+2.5% FeS+2% hexagonal boron nitride+1.5% synthetic solid lubricant

### Example f.)

4% to 8% SnS+2% to 6% hexagonal boron nitride+10% to 17% graphite+0.5% to 3% synthetic solid lubricant based on zinc sulfide with tungsten sulfide and with graphite, for example 6% SnS+4% hexagonal boron nitride+15% graphite+2% synthetic solid lubricant.

By means of these solid lubricant compositions, the following examples of friction linings 8 were produced; however, these do not have a limiting character. All indications regarding the compositions are also to be understood in wt. %.

### EXAMPLE 11

60.0% copper, 10.0% iron, 15.0% feldspar, 1% SnS+2 SnS₂+1.5% Sn₂S₃+5.5% hexagonal boron nitride, 5% aluminum oxide

### EXAMPLE 12

60.0% copper, 2.0% tin, 20,0% kieselguhr, 8% SnS+4% FeS, 2.0% natural graphite, 4.0% corundum

### EXAMPLE 13

60.0% copper, 14.0% iron, 8.0% mica, 1% SnS+2 SnS₂+1.5% Sn₂S₃+5.5% hexagonal boron nitride, 3.5% natural graphite, 4.5% aluminum oxide

### EXAMPLE 14

64.0% copper, 3.0% zinc, 4.0% mica, 6% SnS+4% hexagonal boron nitride+15% graphite+2% synthetic solid lubricant, 2.0% silicon oxide

### EXAMPLE 15

70.0% copper, 8.0% mica, 10.0% feldspar, 4% SnS+3% SnS₂, 5% mullite

### EXAMPLE 16

70.0% copper, 15.0% iron, 4% SnS+2.5% FeS+2% hexagonal boron nitride+1.5% synthetic solid lubricant, 5% silicon oxide

### EXAMPLE 17

90.0% copper, 3% SnS+4% FeS+0.75% synthetic solid lubricant, 2.25% mullite

### EXAMPLE 18

50.0% copper, 9.0% iron, 10.0% kieselguhr, 15.0% mica, 4% SnS+2.5% FeS+2% hexagonal boron nitride+1.5% synthetic solid lubricant, 6% silicon oxide

In the course of validating the invention, inter alia, the friction coefficient accuracy of the friction linings 8 described with more than two solid lubricants in the matrix was determined. FIG. 4 shows the distribution of the friction coefficients for friction linings according to EP 2 012 038 A2 and FIG. 5 shows the distribution of the friction coefficients for friction linings 8 according to the present invention. The friction coefficient is shown on the abscissa and the frequency on the ordinate. In each case 708 samples were measured.

As can immediately be seen from the comparison of the two figures, the friction linings 8 according to the invention have a significantly higher friction coefficient accuracy.

According to the previous statements, a friction assembly according to the invention can therefore also be provided with a friction lining 8 according to one of the following embodiment variants:
with a binder-free, sintered friction lining (8) having a friction lining body, which comprises a metallic matrix, at least one abrasive, solid lubricants, and optionally at least one filling material, wherein the solid lubricants are formed by at least two different solid lubricants, which are selected from a group consisting of hexagonal boron nitride and metal sulfides with at least one metal from the group of tungsten, iron, tin, copper, bismuth, antimony, chromium, zinc, silver, manganese, molybdenum. The friction lining has a significantly improved friction behavior than to be expected based on the disclosure of EP 2 012 038 A2 in which solid lubricants in a friction lining were already described. The improvement mainly relates to the reduction of vibrations during the frictional engagement of the friction lining with a counter friction surface, whereby in further consequence a stabilization of the friction process and hence a reduction of premature wear of the friction lining can be achieved. It is assumed that this improvement is due to the use of at least two different solid lubricants from the mentioned group. Each one of these solid lubricants has correspondingly good properties in specific operating ranges. Hence, the friction lining can be better adapted to a comprehensive load spectrum. The friction lining is therefore more suitable for dry running, i.e. for operating conditions without the dissipation of the emerging frictional heat with an oil. This in turn also reduces the drag torques that would be generated due to the use of oil. Hence, the friction assembly can be built with a small distance of the friction components to one another, whereby the constructional volume of the friction component can be reduced.
with such a binder-free friction lining (8), in which the solid lubricants are formed by at least two metal sulfides comprising the same metal. Thus, mixed sulfides can be used in which the metal is contained in at least two different oxidation stages. Thus, the temperature behavior of the friction lining could be further improved. However, the material compatibility of the individual ingredients of the friction lining's composition can also be improved by using tin sulfides as solid lubricants, for example, if the friction lining also contains tin or intermetallic tin compounds.
with such a binder-free friction lining (8), in which graphite is additionally contained, whereby an improvement of the temperature resistance can be achieved.
with such a binder-free friction lining (8), in which the total proportion of solid lubricants in the friction lining body is selected from a range of 5 wt. % to 30 wt. %. With proportions of solid lubricants in this range, the aforementioned effects are particularly more pronounced.
with such a binder-free friction lining (8), in which the friction lining body contains tin sulfides as solid lubricants, wherein the total proportion of tin sulfides in the friction lining body amounts to between 2 wt. % and 7 wt. %;
with such a binder-free friction lining (8), in which the friction lining body contains iron sulfides as solid lubricants, wherein the total proportion of iron sulfides in the friction lining body amounts to between 1 wt. % and 5 wt. %;
with such a binder-free friction lining (8), in which the friction lining body contains hexagonal boron nitride as solid lubricants, wherein the total proportion of hexagonal boron nitride in the friction lining body amounts to between 1 wt. % and 6 wt. %;
with such a binder-free friction lining (8), in which the friction lining body contains graphite and hexagonal boron nitride as solid lubricants, wherein a ratio of graphite to hexagonal boron nitride is selected from a range of 3 to 6;
with such a binder-free friction lining (8), in which the solid lubricants are partly of a natural origin and partly synthetically produced, wherein a ratio of natural solid lubricant to synthetic solid lubricant is selected from a range of 1.5 to 5;
with such a binder-free friction lining (8), in which the proportion of synthetically produced solid lubricant in the friction lining body amounts to between 0.5 wt. % and 5 wt. %;
with such a binder-free friction lining (8), in which the friction lining body contains SnS and SnS₂ as solid lubricants, wherein the proportion of SnS in the friction lining body amounts to between 2 wt. % and 6 wt. % and the proportion of SnS₂ in the friction lining body amounts to between 1 wt. % and 5 wt. %;
with such a binder-free friction lining (8), in which the friction lining body contains SnS, SnS₂, Sn₂S₃ and hexagonal boron nitride as solid lubricants, wherein the proportion of SnS in the friction lining body amounts to between 0.5 wt. % and 1.5 wt. %, the proportion of SnS₂ in the friction lining body amounts to between 1 wt. % and 3 wt. %, the proportion of Sn₂S₃ in the friction lining body amounts to between 0.5 wt. % and 3 wt. %, and the proportion of hexagonal boron nitride in the friction lining body amounts to between 3.5 wt. % and 7.5 wt. %;
with such a binder-free friction lining (8), in which the friction lining body contains SnS and FeS as solid lubricants, wherein the proportion of SnS in the friction lining body amounts to between 6 wt. % and 10 wt. %, and the proportion of FeS in the friction lining body amounts to between 2 wt. % and 6 wt. %;
with such a binder-free friction lining (8), in which the friction lining body contains SnS, FeS and a synthetic solid lubricant based on zinc sulfide with tungsten sulfide and with graphite as solid lubricants, wherein the proportion of SnS in the friction lining body amounts to between 1 wt. % and 5 wt. %, the proportion of FeS in the friction lining body amounts to between 2 wt. % and 6 wt. % and the proportion of synthetic solid lubricant amounts to between 0.5 wt. % and 1 wt. %;
with such a binder-free friction lining (8), in which the friction lining body contains SnS, FeS, hexagonal boron nitride and a synthetic solid lubricant based on zinc sulfide with tungsten sulfide and with graphite as solid lubricants, wherein the proportion of SnS in the friction lining body amounts to between 2 wt. % and 6 wt. %, the proportion of FeS in the friction lining body amounts to between 1 wt. % and 3.5 wt. %, the proportion of hexagonal boron nitride in the friction lining body amounts to between 0.5 wt. % and 4 wt. % and the proportion of synthetic solid lubricant amounts to between 0.5 wt. % and 3 wt. %;
with such a binder-free friction lining (8), in which the friction lining body contains SnS, hexagonal boron nitride, graphite and a synthetic solid lubricant based on zinc sulfide with tungsten sulfide and with graphite as solid lubricants, wherein the proportion of SnS in the friction lining body amounts to between 4 wt. % and 8 wt. %, the proportion of hexagonal boron nitride in the friction lining body amounts to between 2 wt. % and 6 wt. %, the proportion of graphite in the friction lining body amounts to between 10 wt. % and 17 wt. % and the proportion of synthetic solid lubricant amounts to between 0.5 wt. % and 3 wt. %.

FIGS. 6 to 8 show different embodiment variants of counter discs 3, which may possibly form the subject matter of independent inventions. Moreover, it should be noted that—although it is not shown—combinations of the aforementioned features of the counter disc 3, such as the surface structuring and/or counter disc of the counter disc 2, are possible.

Moreover, all counter discs 3 of a friction assembly may be designed the same or different. The following embodiments can thus possibly also be applied to all counter discs 3 of a friction assembly. Therefore, only one counter disc 3 is described in the following.

As can be seen in FIGS. 6 to 8, the counter disc 3 may be provided with multiple openings 15, which extend through the counter discs 3 in the axial direction 4 (shown in FIG. 1) of the friction assembly. This embodiment of the counter discs 3 is particularly used in dry-running friction assemblies, meaning friction assemblies without lubrication/cooling with a liquid. It is particularly preferred for such counter discs 3 to be used in combination with lining discs 2 (shown in FIG. 1), which have a mass-pressed friction lining 8 as it is described above.

The counter disc 3 may have, for example, between 4 and 60 openings 15, wherein this specification is not to be understood in a limiting way.

The openings 15 are preferably arranged, such that the entire friction area of the friction disc is covered by them, as can be seen in FIGS. 6 to 8.

In the simplest embodiment variant of the counter disc 3, all openings 15 are arranged at the same radial height, for example on a circle, which has a diameter resulting from Di+(Da−Di)/2, wherein Da represents the outer diameter and Di represents the inner diameter of the friction disc. However, the openings 15 may also be arranged at a different radial height, wherein preferably all openings 15 are designed to be completely closed, i.e. not ending in the radially outer and/or the radially inner lateral surface of the counter disc 3. This preferably applies to all embodiment variants of the counter disc 3 with such openings 15.

According to a preferred embodiment variant of the counter disc 3, however, it may be provided that the multiple openings 15 are distributed across different radial heights in the disc body 9, as can be seen in FIGS. 6 and 7, i.e. for example at two different radial heights (FIG. 6), or three different radial heights (FIG. 7), or more different radial heights. In this regard, two openings 15 arranged immediately next to one another in the circumferential direction are preferably arranged at different radial heights, as can be seen in FIGS. 6 and 7. The following sequence of openings 15 can therefore be formed in the circumferential direction: first radial height, second radial height, first radial height, second radial height etc., or first radial height, second radial height, third radial height, first radial height, second radial height, third radial height etc.

The pitch circles of the counter disc 3 defined by the different radial heights are preferred to be formed to be concentric with one another.

In this regard, it may also be provided according to an embodiment variant of the counter disc 3 that the openings are at least partially arranged on top of one another in the radial direction (and spaced apart from one another), as can be seen e.g. in FIG. 7 with the aid of the openings 15′ and 15″.

The openings 15 may have any suitable shape, for example oval, quadrangular, hexagonal etc. (in each case viewed in the direction of the axial direction 4). According to a preferred embodiment variant, however, the openings 15 have a circular surface.

In this regard, it may be provided according to a preferred embodiment variant of the counter disc 3 that the circular surfaces each have a diameter 16 selected from a range between 2 mm and 10 mm, in particular from a range between 4 mm and 7 mm.

As FIG. 8 shows, the openings 15 may also have the shape of an elongated hole. In this regard, the elongated holes may be designed to be straight or oval. However, according to an embodiment variant, they are preferred to be arcuate, meaning formed having an arcuately curved course, as shown in FIG. 8. The curvature is formed in this regard such that the elongated holes extend with a concave curvature from the inside to the outside in the direction of rotation of the counter disc 3.

With the openings 15 not formed as elongated holes, it is also possible to arrange them situated on an arch, as can be seen for example in FIG. 7, in which three openings 15 each are arranged on an arcuated path (starting from an inner opening 15).

It is moreover possible that the openings 15 are arranged at the same radial height, in each case offset by an angle 17 (shown in FIG. 7) selected from a range of 20° to 60°, in particular from a range of 25° to 45°.

Moreover, it may be provided that the openings are arranged at different radial heights, in each case offset by an angle 18 (shown in FIG. 7) selected from a range of 5° to 25°, in particular from a range of 8° to 22°.

In this regard, the angles 17 and 18 are in each case measured between the centers of the openings 15.

The angle 18 is moreover determined between the openings 15 which are situated at radial heights directly on top of one another.

All openings 15 of a counter disc 3 may be of the same shape and/or size. However, it is also possible that the openings 15 of a counter disc 3 are formed differently, for example having different shapes and/or different sizes. For example, it may be provided that the radially innermost openings 15 are smallest and that the size of the openings 15 increases in the radial direction from the inside to the outside.

It may further be provided that transitions between the axial surface of the counter disc 3 and the openings 15 is slanted and/or rounded in order to thus improve the intake of wear debris particles in the openings 15.

The exemplary embodiments show and/or describe possible embodiment variants, while it should be noted at this point that combinations of the individual embodiment variants are also possible.

Finally, as a matter of form, it should be noted that for ease of understanding of the structure of the friction assembly and/or the disc pack 1 and of the discs, these are not obligatorily depicted to scale.

The counter disc 3 with the openings 15 may be the subject matter of an independent invention, which relates to a dry-running friction assembly per se.

### LIST OF REFERENCE NUMBERS

1 Disc pack
2 Lining disc
3 Counter disc
4 Axial direction
5 Carrier disc
6 Surface
7 Surface
8 Friction lining
9 Disc body
10 Driver element
11 Driver element
12 Segment
13 Distance
14 Width
15 Opening
16 Diameter
17 Angle
18 Angle

1. A friction assembly comprising a dry-running disc pack (1) with at least one lining disc (2) and at least one counter disc (3), which are arranged one behind the other in an alternating manner in an axial direction (4) of the disc pack (1), and which can be brought into frictional contact with one another, wherein the lining disc (2) has at least one dry-running friction lining, which is a mass-pressed friction lining (8), wherein the friction lining (8) has a porosity of greater than 10%.

2. The friction assembly according to claim 1, wherein the friction lining (8) is a press sintered friction lining.

3. The friction assembly according to claim 2, wherein the press sintered friction lining is a sintered metal lining or a press sintered friction lining comprising an organic material.

4. The friction assembly according to claim 1, wherein the friction lining (8) is arranged on a carrier disc (5).

5. The friction assembly according to claim 4, wherein the friction lining (8) is connected to the carrier disc (5) via a connecting layer.

6. The friction assembly according to claim 1, wherein the friction lining (8) is segmented.

7. The friction assembly according to claim 1, wherein a surface of the friction lining (8) is structured and/or provided with a coating.

8. The friction assembly according to claim 1, wherein a surface of the counter disc is structured and/or provided with a coating.

9. The friction assembly according to claim 1, wherein the friction lining (8) comprises at least one abrasive, wherein the proportion of the abrasive in the friction lining amounts to a maximum of 5 wt. %.

10. The friction assembly according to claim 1, wherein the friction lining (8) has a porosity selected from a range having a lower limit of 15% and an upper limit of 40%.

11. The friction assembly according to claim 1, wherein the friction lining (8) comprises a metallic matrix, and that the proportion of the metallic matrix in the friction lining (8) is selected from a range having a lower limit of 60 wt. % and an upper limit of 90 wt. %.

12. The friction assembly according to claim 11, wherein the metallic matrix is formed from at least one element from a group comprising copper, iron, tin, zinc, or alloy and mixtures thereof.

13. The friction assembly according to claim 1, wherein the friction assembly (8) comprises at least one filling material that is different from the abrasive, and that the proportion of the at least one filling material in the friction lining (8) is selected from a range having a lower limit of 5 wt. % and an upper limit of 35 wt. %.

14. The friction assembly according to claim 13, wherein the at least one filling material is a silicate filling material.

15. The friction assembly according to claim 14, wherein the at least one filling material is selected from a group comprising mica, feldspar, kieselguhr, or mixtures thereof.

16. The friction assembly according to claim 9, wherein the at least one abrasive is selected from a group comprising mullite, silicon dioxide, corundum, glass, aluminum oxide, as well as mixtures thereof.

17. The friction assembly according to claim 1, wherein at least one solid lubricant is contained in the friction lining (8), which solid lubricant is selected from a group comprising graphite, molybdenum disulfide, coke, as well as mixtures thereof.

18. The friction assembly according to claim 17, wherein the proportion of the solid lubricant in the friction lining (8) is selected from a range having a lower limit of 2 wt. % and an upper limit of 30 wt. %.

19. The friction assembly according to claim 1, wherein the friction assembly is a clutch or brake.

20. The friction assembly according to claim 1, wherein the counter disc (3) in the disc body (9) has multiple openings (15).

21. The friction assembly according to claim 20, wherein the openings (15) in the disc body (9) of the counter disc (3) are arranged at different radial heights.

22. The friction assembly according to claim 20, wherein the openings (15) are formed having a circular surface.

23. The friction assembly according to claim 22, wherein the circular surfaces each have a diameter (16) selected from a range of 2 mm to 10 mm.

24. The friction assembly according to claim 20, wherein the openings (15) are formed as elongated holes.

25. The friction assembly according to claim 24, wherein the elongated holes have an arcuate course.

26. The friction assembly according to claim 20, wherein the openings (15) are at least partially arranged on top of one another in the radial direction.

27. The friction assembly according to claim 20, wherein the openings (15), which are arranged at the same radial height, are in each case offset by an angle (17) selected from a range of 20° to 60°.

28. The friction assembly according to claim 21, wherein the openings (15), which are arranged at different radial heights, are in each case offset by an angle (18) selected from a range of 5° to 25°.

29. A use of the friction assembly according to claim 1 in a clutch or a brake or in a synchromesh transmission of an AWD drive or FWD drive.
